(19) United States
(12) Patent Application Publication
(10) Pub. No.: US 2018/0093678 A1
(43) Pub. Date: Apr. 5, 2018

(54) AUGMENTED REALITY ENHANCED NAVIGATION

(71) Applicant: Wal-Mart Stores, Inc., Bentonville, AR (US)

(72) Inventors: Anthony G. Wind, III, Gravette, AR (US); Robert R. Albrecht, Rogers, AR (US); Timothy J. Hinrichs, Rogers, AR (US); Mark Bullard, Rogers, AR (US); Larry Kraus, Bella Vista, AR (US)

(21) Appl. No.: 15/724,578

(22) Filed: Oct. 4, 2017

Related U.S. Application Data
(60) Provisional application No. 62/403,743, filed on Oct. 4, 2016.

(51) Int. Cl. B60W 50/14; G06T 19/00; G01S 13/93; G08G 1/16; G06K 9/00

(52) U.S. Cl. CPC B60W 50/14; G06T 19/006; G01S 13/931; B60W 2050/146; G06K 9/00818; G06K 9/00805; G08G 1/166

(57) ABSTRACT

A control circuit detects a present navigation concern within a physical boundary such as a building and augments the presentation of a piloted vehicle's pilot's field of view to include cautionary imagery regarding the present navigation concern. Examples of navigation concerns include but are not limited to a risk of colliding with another piloted vehicle, human activity in the physical boundary, and a blocked-passageway state of concern. Examples of cautionary imagery include but are not limited to an image of a STOP sign, an image of a traffic light, and an image of a barrier.

### RELATED APPLICATION(s)

This application claims the benefit of U.S. Provisional application No. 62/403,743, filed Oct. 4, 2016, which is incorporated by reference in its entirety herein.

### TECHNICAL FIELD

These teachings relate generally to the navigation of human-piloted vehicles and more particularly to the use of augmented reality in conjunction therewith.

### BACKGROUND

Human-piloted vehicles are well known in the art. In some application settings human-piloted vehicles are navigated primarily or wholly within a building. For example, forklifts and other cargo-carrying vehicles are often employed in a warehouse setting to move items from one place to another within a building.

Moving a vehicle under any circumstances raises the corresponding risk of a collision between the vehicle and another object and/or some other unwanted interaction between the vehicle and the operating environment. When operating a vehicle inside a building, these risks can at least be different than, and sometimes greater than, the risks encountered when operating the vehicle in an outside environment. For example, operating conditions within a building can be relatively tightly contained and may include a mix of other vehicles (both human-piloted and autonomously piloted), human pedestrians, and a variety of temporary blockages or other concerns (such as spilled liquids or other materials).

As a result, human pilots operating under such circumstances must often operate in a highly-aware state. Unfortunately, it can be difficult for many people to maintain a heightened state of awareness, focus, and concentration in these regards for a sufficient duration of time. Furthermore, even when suitably aware, it can sometimes be difficult for a human pilot to properly interpret a particular scene in order to take an appropriate piloting action.

### BRIEF DESCRIPTION OF THE DRAWINGS

The above needs are at least partially met through provision of the augmented reality enhanced navigation described in the following detailed description, particularly when studied in conjunction with the drawings, wherein:

FIG. 1 comprises a block diagram as configured in accordance with various embodiments of these teachings;

FIG. 2 comprises a flow diagram as configured in accordance with various embodiments of these teachings;

FIG. 3 comprises a screenshot as configured in accordance with various embodiments of these teachings;

FIG. 4 comprises a screen shot detail as configured in accordance with various embodiments of these teachings; and

FIG. 5 comprises a screen shot detail as configured in accordance with various embodiments of these teachings.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present teachings. Also, common but well-understood elements that are useful or necessary in a commercially feasible embodiment are often not depicted in order to facilitate a less obstructed view of these various embodiments of the present teachings. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to these various embodiments a control circuit detects a present navigation concern within a physical boundary such as a building and augments the presentation of a piloted vehicle's pilot's field of view to include cautionary imagery regarding the present navigation concern. Examples of navigation concerns include but are not limited to a risk of colliding with another piloted vehicle, human activity within the physical boundary, and a blocked-passageway state of concern. Examples of cautionary imagery include but are not limited to an image of a STOP sign, an image of a traffic light, and an image of a barrier.

So configured, the pilot of a piloted vehicle, such as a driver of a human-piloted vehicle, operating in a physical boundary can carry out their assigned tasks with greater corresponding safety for themselves, other piloted vehicles (including both human-piloted vehicles as well as human-piloted vehicles), fellow workers, and building infrastructure and products. These teachings can be configured to provide highly intuitive content and thus avoid a need for significant training requirements. For example, the aforementioned cautionary imagery can employ imagery with which the pilot is likely already familiar from their environmental and/or cultural upbringing and experiences.

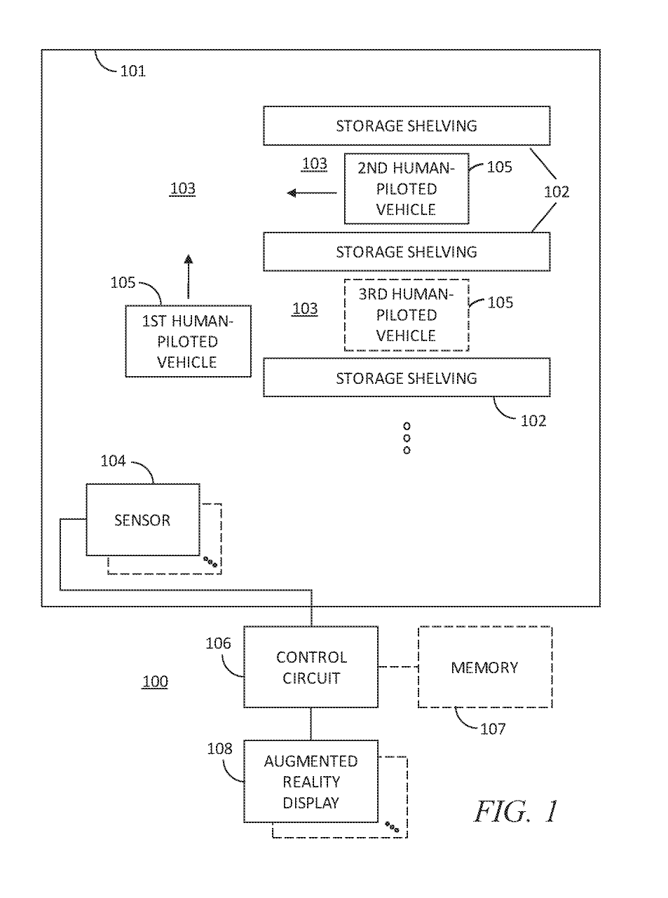

These and other benefits may become clearer upon making a thorough review and study of the following detailed description. Referring now to the drawings, FIG. 1 presents an illustrative example of an enabling apparatus 100. Those skilled in the art will recognize and understand that the specifics of this example are intended to serve an illustrative purpose and are not intended to suggest any particular limitations in these regards.

In this illustrative example the apparatus 100 includes a physical boundary. For the sake of an illustrative example but without intending any particular limitations in these regards, it will be presumed here that this physical boundary comprises a building 101. In this description the building is further presumed to comprise a warehouse though other building types and purposes will also suffice. A warehouse is a commercial building designed and intended for the storage of goods. Warehouses are used by manufacturers, importers, exporters, wholesalers, retailers and others. Warehouses often have loading docks to load and unload goods from trucks/trailers though some are designed for the loading and unloading of goods directly from railways, airports, or seaports. Stored goods can include any raw materials, packing materials, spare parts, components, or finished goods as desired.

In this example this building 101 includes a plurality of driving lanes 103. In at least some cases the driving lane 103 is bordered by or even at least partially defined by storage shelving 102. These driving lanes 103 provide a pathway for human-piloted vehicles (including vehicles in which the human pilot is physically present as well as remotely-piloted vehicles where the human pilot is not physically present in the vehicle), autonomous vehicles, pedestrians, and so forth as desired. These driving lanes 103 may be specifically delineated (by, for example, painted lines on the floor), in whole or in part, as desired. In a typical application setting one driving lane 103 will, from time to time, intersect with one or more other driving lanes 103.

Also in this example this building 101 includes one or more sensors 104. For the purposes of this description these sensors 104 provide information that can help to identify, directly or indirectly, navigational concerns within the building 101. These teachings will accommodate a wide range of sensors and sensory modalities. Examples include but are not limited to still-image cameras, video cameras, proximity sensors, distance sensors, heat sensors, weight sensors, radio-frequency identification (RFID) readers, optical code readers, wireless receivers and transceivers, and so forth. Such sensors 104 can be permanently mounted or can be selectively movable and/or a mobile as desired.

This apparatus 100 also includes a plurality of human-piloted vehicles 105 disposed within the building 101. In a typical application setting the human-piloted vehicle 105 will be driven by an on-board human pilot. In other cases the vehicle 105 may be driven by a remotely-located human pilot. These teachings will accommodate both use cases. These teachings will accommodate a wide variety of human-piloted vehicles 105 including, for example, human-piloted forklifts and other cargo-conveying conveyances.

In this illustrative example the apparatus 100 further includes a control circuit 106. Being a “circuit,” the control circuit 106 therefore comprises structure that includes at least one (and typically many) electrically-conductive paths (such as paths comprised of a conductive metal such as copper or silver) that convey electricity in an ordered manner, which path(s) will also typically include corresponding electrical components (both passive (such as resistors and capacitors) and active (such as any of a variety of semiconductor-based devices) as appropriate) to permit the circuit to effect the control aspect of these teachings.

Such a control circuit 106 can comprise a fixed-purpose hard-wired hardware platform (including but not limited to an application-specific integrated circuit (ASIC) (which is an integrated circuit that is customized by design for a particular use, rather than intended for general-purpose use), a field-programmable gate array (FPGA), and the like) or can comprise a partially or wholly-programmable hardware platform (including but not limited to microcontrollers, microprocessors, and the like). These architectural options for such structures are well known and understood in the art and require no further description here. This control circuit 106 is configured (for example, by using corresponding programming as will be well understood by those skilled in the art) to carry out one or more of the steps, actions, and/or functions described herein.

By one optional approach the control circuit 106 operably couples to an optional memory 107. This memory 107 may be integral to the control circuit 106 or can be physically discrete (in whole or in part) from the control circuit 106 as desired. This memory 107 can also be local with respect to the control circuit 106 (where, for example, both share a common circuit board, chassis, power supply, and/or housing) or can be partially or wholly remote with respect to the control circuit 106 (where, for example, the memory 107 is physically located in another facility, metropolitan area, or even country as compared to the control circuit 106).

This memory 107 can serve, for example, to non-transitorily store the computer instructions that, when executed by the control circuit 106, cause the control circuit 106 to behave as described herein. (As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as an erasable programmable read-only memory (EPROM).)

In addition to operably coupling to the aforementioned sensor(s) 104, the control circuit 106 also operably connects to at least one augmented reality display 108. This augmented reality display 108 is configured to provide at least one driver of one of the human-piloted vehicles 105 with an augmented presentation of their field of view. By one approach the augmented reality display 108 comprises a head-worn display. The augmented reality display 108 can include, or, in the alternative, is not accompanied by, augmented reality audio content as desired.

Augmented reality comprises a well-understood area of prior art endeavor. Augmented reality typically comprises a live direct or indirect view of a physical, real-world environment whose elements are augmented (or supplemented) by computer-generated visual input. This augmentation typically occurs in real-time and in relevant context with visible real-world environmental elements. For example, an augmented reality display presents information about the environment and its objects by overlaying that information on the view of the real world.

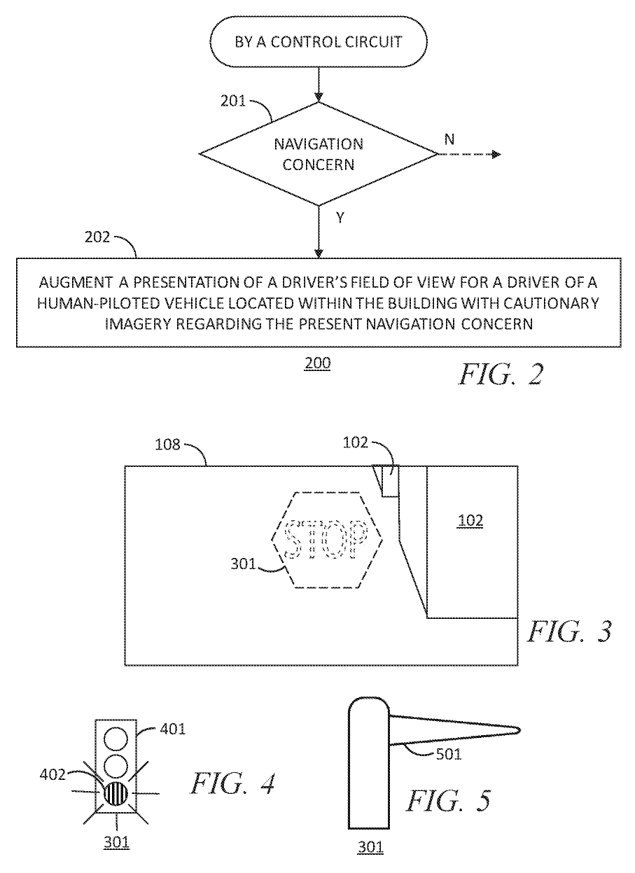

By one approach the control circuit 106 is configured to carry out the process 200 presented in FIG. 2.

At decision block 201 the control circuit 106 detects a present navigation concern as regards a particular one of the human-piloted vehicles 105 within the building 101. (In the absence of detecting a trigger event this process 200 can accommodate any of a variety of responses. Examples of responses can include temporal multitasking (pursuant to which the control circuit 106 conducts other tasks before returning to again monitor for a navigation concern) as well as continually looping back to essentially continuously monitor for a navigation concern(s). These teachings also accommodate supporting this detection activity via a real-time interrupt capability.)

These teachings will accommodate monitoring for only a single particular kind of navigation concern or for any of a plurality of differing navigation concerns as desired. Examples of navigation concerns include navigation concerns regarding human-piloted vehicles 105 other than the monitored vehicle, such as a risk of the monitored vehicle colliding with another human-piloted vehicle 105. FIG. 1 provides an illustrative example in this regard. In particular, a first human-powered vehicle 105 is heading in a first direction and is at risk of colliding with a second human-powered vehicle 105 that is approaching from the right. Taking into account the present headings, velocities (or acceleration when present), and relative distances that separate these two vehicles, the control circuit 106 can calculate whether a collision is likely to occur absent some change to at least one of the foregoing variables.

Other examples of navigation concerns of potential interest include but are not limited to (1) human activity in a particular part of the building 101 that places such persons at risk of being struck by one of the human-piloted vehicles 105 and (2) any of a variety of blocked-passageway states of concern. A blocked-passageway state of concern can comprise, for example, spillage (liquid or otherwise) of product that is stored in the building 101. Other examples include weight-restricted surfaces (such as, for example, a bridge between two buildings in a warehouse complex) and steep slopes (including both inclines and declines).

The control circuit 106 can base the aforementioned detection of a navigation concern, at least in part, upon the input from one or more of the aforementioned sensors 104. Images provided by cameras, for example, can be compared to a reference library of pattern images to identify a liquid spill, the presence of people, or the presence of a particular type of vehicle (human-piloted or otherwise).

By one approach the control circuit 106 can take other factors into account when detecting navigational concerns. For example, the control circuit 106 can take the weight of the vehicle (as loaded or otherwise as desired) into account when determining whether a particular sloped surface in fact represents a navigational concern or when determining whether the vehicle has sufficient braking capability to come to a complete halt under certain operating circumstances. As another example, the control circuit 106 may take into account the operating experience of the vehicle's driver and accordingly may use a lower threshold when detecting navigational concerns when the driver has less driving experience or training.

By one approach the control circuit 106 can be configured to detect a same navigation concern over a consecutive number of sampling/detection windows before actually “detecting” the presence of a genuine navigation concern. For example, the control circuit 106 may require that the same concern be sequentially/repeatedly and continuously detected over 10 milliseconds or some other time frame of preference. Such an approach can help to avoid false positives without unnecessarily impairing the responsiveness of the process 200.

Upon detecting a navigation concern, the control circuit 106, at block 202, facilitates or itself causes the presentation of the driver's field of view for the affected human-piloted vehicle(s) 105 as provided via a corresponding augmented reality display 108 to be augmented with cautionary imagery regarding the detected present navigation concern. FIG. 3 presents one example in these regards. In this example the augmented reality display 108 presents a live view of real-world content that is presently within the driver's field of view (in this case, that real-world content including the aforementioned storage shelving 102) in combination with cautionary imagery 301 in the form of a standard STOP sign. The intent of providing such a STOP sign, of course, is to prompt the driver of the vehicle 105 to bring their vehicle to a halt to thereby avoid an otherwise-anticipated collision with another vehicle, a pedestrian, spillage, or the like.

These teachings will accommodate a wide variety of cautionary images. As shown in FIG. 4, for example, the imagery 301 can comprise a traffic light 401 that features light positions for a green-colored light, a yellow-colored light, and a red-colored light 402. Here, the red-colored light 402 appears illuminated (as compared to the green and yellow-colored lights, which are not illuminated). Accordingly, this traffic light image conveys the same cautionary message as the above-described STOP sign.

FIG. 5 presents yet another example in these regards. In this example the cautionary imagery 301 comprises an image of a barrier 501 (in this case, a so-called boom barrier). Such an image again serves to convey the message to stop the vehicle from progressing further.

As already noted above, other cautionary images can serve as well if desired. Examples include detour signs, yield signs, instructions to reduce speed, weight restriction cautions, steep slopes (i.e., an incline or a decline) or steps, narrowed passageways, hidden doorways, uneven or rough surfaces, and so forth.

So configured, the use of vehicles within a building can be undertaken with considerably reduced risk of harm, damage, or accident-based delay. The images provided to the drivers of in-building vehicles can be simple and intuitive, thereby requiring little or no driver training.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

What is claimed is:

1. An apparatus comprising:
a physical boundary;
a plurality of piloted vehicles disposed within the physical boundary;
at least one augmented reality display configured to provide at least one pilot of one of the piloted vehicles with an augmented presentation of their field of view;
a control circuit operably coupled to the at least one augmented reality display and configured to:
detect a present navigation concern within the physical boundary; and
augment the presentation of the pilot's field of view with cautionary imagery regarding the present navigation concern.

2. The apparatus of claim 1 wherein the physical boundary comprises a warehouse.

3. The apparatus of claim 2 wherein the warehouse includes driving lanes bordered, at least in part, by storage shelving.

4. The apparatus of claim 1 wherein the piloted vehicles include human-piloted forklifts.

5. The apparatus of claim 1 wherein the augmented reality display comprises a head-worn display.

6. The apparatus of claim 1 wherein the augmented reality display is not accompanied by augmented reality audio content.

7. The apparatus of claim 1 wherein the present navigation concern comprises another of the piloted vehicles.

8. The apparatus of claim 7 wherein the present navigation concern comprises a risk of colliding with the another of the piloted vehicles.

9. The apparatus of claim 1 wherein the present navigation concern comprises human activity in a particular part within the physical boundary.

10. The apparatus of claim 1 wherein the present navigation concern comprises a blocked-passageway state of concern.

11. The apparatus of claim 10 wherein the blocked-passageway state of concern comprises spillage.

12. The apparatus of claim 1 wherein the cautionary imagery comprises at least one of:
an image of a STOP sign;
an image of a traffic light;
an image of a barrier.

13. A method comprising:
automatically detecting a present navigation concern within a physical boundary; and
augmenting a presentation of a pilot's field of view for a pilot of a piloted vehicle located within the physical boundary with cautionary imagery regarding the present navigation concern.

14. The method of claim 13 wherein the physical boundary comprises a warehouse.

15. The method of claim 14 wherein the augmenting of the presentation of the pilot's field of view comprises using a head-worn display to present the augmented presentation of the pilot's field of view.

16. The method of claim 13 wherein the present navigation concern comprises another of the piloted vehicles.

17. The method of claim 16 wherein the present navigation concern comprises a risk of colliding with the another of the piloted vehicles.

18. The method of claim 13 wherein the present navigation concern comprises a blocked-passageway state of concern.

19. The method of claim 18 wherein the blocked-passageway state of concern comprises spillage.

20. The method of claim 13 wherein the cautionary imagery comprises at least one of:
an image of a STOP sign;
an image of a traffic light;
an image of a barrier.
